(19) United States
(12) Patent Application Publication
(10) Pub. No.: US 2010/0105812 A1
(43) Pub. Date: Apr. 29, 2010

(54) COPOLYAMIDE, COMPOSITION CONTAINING SUCH COPOLYAMIDE AND USE THEREOF

(75) Inventors: Philippe Bussi, Versailles (FR); Heike Faulhammer, Saint Germain en Laye (FR); Guillaume Le, Colombelles (FR); Quentin Pineau, Evreux (FR)

Correspondence Address: ARKEMA INC.;PATENT DEPARTMENT - 26TH FLOOR, 2000 MARKET STREET, PHILADELPHIA, PA, 19103-3222, US

(73) Assignee: ARKEMA FRANCE, Colombes (FR)

(21) Appl. No.: 12/526,982

(22) PCT Filed: Feb. 15, 2008
(86) PCT No.: PCT/FR2008/050251

§ 371 Date: Dec. 15, 2009

(30) Foreign Application Priority Data
Feb. 16, 2007 (FR) 0753319

(51) Int. Cl. C08L 77/06; C08G 69/26; C08L 1/00; C08L 3/02

(52) U.S. Cl. 524/35; 528/338; 528/335; 524/47; 525/411; 525/435

(57) ABSTRACT

The invention relates to a copolyamide containing at least two patterns (monomers) and of the following general formula A/(Cz diamine)·(Cw diacid) in which: z is the number of carbon atoms of the diamine and w is the number of carbon atoms of the diacid; and A is selected from a pattern obtained from an amino acid and a pattern of the general formula (Cx diamine)·(Cy diacid)_{y}, wherein x is the number of carbon atoms of the diamine and y is the number of carbon atoms of the diacid, the amino acid, each diamine and each diacid being obtained from a renewable raw material according to ASTM D6866 standard. The invention also relates to a composition containing the copolyamide and to the use of this copolyamide and of such a composition, essentially for producing thermofusable glues, in any form thereof.

The present invention relates to a copolyamide and also to its use, especially as a hot-melt adhesive or glue.

The invention also relates to a composition comprising such a copolyamide and also to the use of this composition.

Generally, copolyamides, which comprise at least two monomers, are prepared from amino acids and/or carboxylic diacids and diamines.

Among the copolyamides, mention may especially be made of the copolyamides which correspond to the following general formula:

A/(diamine)_{z}·(diacid)_{w}

in which:
z represents the carbon number of the diamine and w represents the carbon number of the diacid; and
A is chosen from an amino acid and a polyamide corresponding to the formula (diamine)ₓ·(diacid)_{y}, with x representing the carbon number of the diamine and y representing the carbon number of the diacid.

Thus, Patent Application DE OS 1594233 describes copolyamides resulting either from the condensation of lauryl lactam and caprolactam, or from the condensation (i) of lauryl lactam and (ii) hexamethylenediamine and adipic acid in stoichiometric proportions, or else from the condensation (i) of lauryl lactam, (ii) caprolactam and (iii) hexamethylenediamine and adipic acid in stoichiometric proportions.

Patent Application DE OS 2324160 describes copolyamides resulting from the condensation of lauryl lactam, 11-aminoundecanoic acid, caprolactam and hexamethylenediamine with one or more diacids having from 6 to 13 carbon atoms.

Patent Application EP 0 627 454 describes copolyamides resulting from the condensation of at least 10 wt % of lauryl lactam or of 11-aminoundecanoic acid and hexamethylenediamine with one or more diacids having from 6 to 12 carbon atoms.

Patent Application EP 1 153 957 describes copolyamides resulting from the condensation of caprolactam, lauryl lactam or 11-aminoundecanoic acid and a diamine with at least two diacids having from 6 to 14 carbon atoms.

These copolyamides described by the documents of the prior art which have just been cited, are used, alone or as a mixture, as adhesives of the “hot-melt adhesive” (or HMA) type, that is to say that they are deposited in the melt state on the surfaces to be bonded, the adhesion then being obtained by cooling, by the copolyamides returning to the solid state.

However, these copolyamides are obtained from monomers derived, for the most part, from the oil industry and therefore do not correspond to at least one of the concerns falling with the context of sustainable development which is the reduction of fossil resources which are at the root of petrochemistry.

Furthermore, among the copolyamides described in the prior art, those which are more particularly obtained from caprolactam have the additional drawback of releasing volatile organic compounds (VOCs) during their use and of causing a “fogging” phenomenon such as, for example, described in the VDA 278 standard.

Thus, to respond to the concerns mentioned above and more generally for the sake of protecting the environment, alternative solutions to the known copolyamides, including those described above, are actively sought.

In particular, as an alternative to the oil resources, Application WO 94/10257 describes HMA-type adhesive compositions comprising from 20 to 80 wt % of polylactic acid (PLA), from 2 to 20 wt % of a polar adhesive resin and, optionally, a plasticizer or else a stabilizer. These adhesive compositions are described as being biodegradable under relatively gentle conditions, by contact with the earth or during a composting treatment.

However, due to its biodegradability, the use of PLA cannot be envisaged in all applications, in particular in the field of HMA-type adhesive compositions where such PLA-based compositions are not completely satisfactory. The greatest handicap of PLA-based compositions is the poor water resistance at temperatures starting from 50° C.

Hot-melt adhesives based on starch or on its derivatives (for example dextrins) are themselves highly water-sensitive and therefore cannot be used in certain applications in the presence of high relative humidity.

The objective of the present invention is therefore to respond to some of the concerns of sustainable development while overcoming the drawbacks of adhesive compositions such as those based on PLA or on starch.

This objective is achieved by a copolyamide of the aforementioned type, that is to say comprising at least two monomers and corresponding to the general formula A/(diamine)_{z}·(diacid)_{w}, this copolyamide being such that the amino acid, each diamine and each diacid are obtained from a renewable raw material.

A renewable raw material is a natural, animal or plant resource, the stock of which may be regenerated over a short period on the human scale. In particular, it is necessary that this stock can be renewed as quickly as it is consumed.

Thus, by the deliberate choice of monomers which are all obtained from a renewable raw material, copolyamides are obtained which have chemical and thermal properties completely equivalent to those of the copolyamides of the prior art obtained with caprolactam and/or lauryl lactam but which, in addition, respond to at least one of the concerns of sustainable development mentioned above. In particular, the implementation and use of the copolymers according to the invention do not generate any emission of volatile organic compounds (VOCs) nor “fogging”.

For example, these monomers may be derived from renewable resources such as vegetable oils or natural polysaccharides such as starch or cellulose, the starch possibly being extracted, for example, from maize or potato.

These copolyamides are therefore composed of 100% organic carbon derived from renewable resources, which could be certified according to JORA or the ASTM D6866 standard. Not, however, being biodegradable according to the current standards (for example EN13432, the “Green Pla Certification” in Japan and the ASTM 6400 standard in the United States), these copolyamides may be used in a large number of applications, as will be seen below, especially in the textile and motor vehicle fields and, at the very least, in the applications that are already known for copolyamides obtained, for example, with caprolactam or lauryl lactam.

The invention also relates to a composition comprising at least one copolyamide such as described above.

In particular, the composition according to the invention may be an adhesive composition.

Such an adhesive composition has many applications in the textile, electronics and motor vehicle industries, for example.

The invention also relates to the use of such a copolyamide and also to the use of a composition comprising at least one such copolyamide, such uses targeting, in particular, adhesives of the hot-melt adhesive (HMA) type.

Specifically, it is observed that the copolyamides according to the invention melt at relatively low temperature, especially at melting points between 80 and 150° C. Therefore, the present invention retains all the advantages of the copolyamides based on monomers derived from the oil industry while being composed of 100% organic carbon derived from renewable resources.

According to a first aspect of the invention, the copolyamides correspond to the formula A/(diamine)_{z}·(diacid)_{w}.

More particularly, in the A/(diamine)_{z}·(diacid)_{w} formula of the copolyamide according to the invention, the (diamine)_{z} denotes a diamine of formula H₂N-(CH₂)_{z}—NH₂ in which z indicates the number of carbons present in the diamine, z being, of course, an integer strictly greater than 0.

Similarly, in the formula A/(diamine)_{z}·(diacid)_{w}, the (diacid)_{w} denotes a diacid of formula HOOC—(CH₂)_{w-2}—COOH in which w indicates the total number of carbons present in the diacid, w being, of course, an integer strictly greater than 0.

The number of carbons z of the diamine and the number of carbons w of the diacid of the (diamine)_{z}·(diacid)_{w} monomer of the copolyamide according to the invention are preferably each between 4 and 36.

Preferably, the diamine is chosen from butanediamine (z=4), nonanediamine (z=9), decanediamine (z=10), undecanediamine (z=11), tridecanediamine (z=13), octadecanediamine (z=18), octadecenediamine (z=18) and diamines obtained from fatty acids.

Preferably, the diacid is chosen from succinic acid (w=4), azelaic acid (w=9), sebacic acid (w=10), undecanedioic acid (w=11), brassylic acid (w=13), octadecanoic acid (w=18), octadecenoic acid (w=18) and dimers of fatty acids.

Mention will preferably be made of the fatty acid dimers and the corresponding diamines which are compounds mainly containing 36 carbons. This is due to their natural origin.

The molar proportions of (diamine)_{z} and of (diacid)_{w} are preferably stoichiometric.

According to a first variant of the invention, the monomer A in the general formula A/(diamine)_{z}·(diacid)_{w} is an amino acid, this amino acid being obtained from a renewable raw material.

More preferably, A is chosen from 11-aminoundecanoic acid and n-heptyl-11-aminodecanoic acid.

In the remainder of the present description, 11-aminoundecanoic acid will be symbolized by the number 11.

The (diamine)_{z}·(diacid)_{w} monomer in the formula A/(diamine)_{z}·(diacid)_{w} may be composed of any possible diamine and diacid combination and, in particular, by any combination of the diamines and diacids which have been listed above.

Thus, by symbolizing the diamines and the diacids by their respective carbon number z and w, it is therefore especially possible to envisage the use of the following monomers: 4,4, 4,9, 4,10, 4,11, 4,13, 4,18 and 4,36 when considering butanediamine. Similar reasoning may be used for all the other diamines for which z=9, 10, 11, 13, 18 or 36.

Among the combinations that can envisaged, the following copolyamides have a particularly pronounced advantage: these are copolyamides corresponding to one of the formulae chosen from 11/9,18, 11/10,10, 11/10,18, 11/9,36 and 11/10,36.

This is because such copolyamides, depending on their composition, and more precisely the weight proportions of diamine monomers/diacid monomers, may have a melting point, measured by DSC (differential scanning calorimetry), which is between 80° C. and 150° C. and a melt flow index (MFI) between 1 and 80 g/10 min (2.16 kg/180° C.).

Due to these properties, these copolyamides, alone or as a blend with one or more other polymers derived from renewable resources, such as polylactic acid (PLA), polyhydroxyalkanoates and polysaccharides, the latter possibly being modified and/or formulated, may form adhesives that can be used in the textile or motor vehicle industry.

According to a second variant of the invention, the monomer A, in the general formula A/(diamine)_{z}·(diacid)_{w} is a polyamide corresponding to the formula (diamine)ₓ·(diacid)_{y}, x indicating the number of carbons present in the diamine of formula H₂N—(CH₂)ₓ—NH₂ and y indicating the number of carbons present in the diacid of formula HOOC—(CH₂)_{y-2}—COOH respectively.

The numbers x and y are, of course, integers strictly greater than 0 and are, preferably, each between 4 and 36.

For the preferred choice of diamines and diacids of the (diamine)ₓ·(diacid)_{y} monomer, reference will be made to what has been described previously for the preferred diamines and diacids of the (diamine)_{z}·(diacid)_{w} monomer.

Thus, the diamines for which x=4, 9, 10, 11, 13, 18, 36 and the diacids for which y=4, 9, 10, 11, 13, 18 and the fatty acid dimers for which y=36 are more preferably retained.

Of course, the particular cases for which the (diamine)ₓ·diacid)_{y} and (diamine)_{z}·(diacid)_{w} monomers are strictly identical are excluded.

Among all the possible combinations for the (diamine)ₓ·(diacid)_{y}/(diamine)_{z}·(diacid)_{w} copolyamides, in particular the copolyamides corresponding to one of the formulae chosen from 10,10/9,18, 10,10/10,18, 10,1019,36 and 10,10110,36 will be retained.

These copolyamides, depending on their composition, have a melting point, measured by DSC (differential scanning calorimetry) which is between 80° C. and 150° C. and a melt flow index (MFI) between 1 and 80 g/10 min (2.16 kg/180° C.).

The molar proportions of (diamine)ₓ and of (diacid)_{y} are preferably stoichiometric.

According to a second aspect of the invention, the copolyamides comprise, in addition, at least a third monomer, thus corresponding to the following general formula:

A/(diamine)_{z}·(diacid)_{w}/(diamine)ₜ·(diacid)ᵤ

in which t represents the carbon number of the diamine and u represents the carbon number of the diacid, each diamine and each diacid being obtained from a renewable raw material.

In the A/(diamine)_{z}·(diacid)_{w}/(diamine)ₜ·(diacid)ᵤ formula of the copolyamide according to the second aspect of the invention, reference will be made to what has been described previously for the A and (diamine)_{z}·(diacid)_{w} monomers.

In this same formula, the (diamine)ₜ denotes a diamine of formula H₂N—(CH₂)ₜ—NH₂ in which t indicates the number of carbons present in the diamine, t being, of course, an integer strictly greater than 0.

Similarly, in this formula, the (diacid)ᵤ denotes a diacid of formula HOOC—(CH₂)ᵤ₋₂—COOH in which u indicates the total number of carbons present in the diacid, u being, of course, an integer strictly greater than 0.

The number of carbons t of the diamine and the number of carbons u of the diacid of the (diamine)ₜ·(diacid)ᵤ monomer of the copolyamide according to the invention are preferably each between 4 and 36.

For the preferred choice of the diamines and diacids of the (diamine)ₜ·(diacid)ᵤ monomer, reference will be made to what has been described previously for the preferred diamines and diacids of the (diamine)_{z}·(diacid)_{w} monomer.

Thus, the diamines for which t=4, 9, 10, 11, 13, 18, 36 and the diacids for which u=4, 9, 10, 11, 13, 18 and the fatty acid dimers for which u=36 are more preferably retained.

Obviously, the particular cases for which the (diamine)ₓ·(diacid)_{y}, (diamine)_{z}·(diacid)_{w} and (diamine)ₜ·(diacid)ᵤ monomers are strictly identical, at least in pairs, are excluded.

Among all the possible combinations for the (diamine)ₓ·(diacid)_{y}/(diamine)_{z}·(diacid)_{w}/(diamine)ₜ·(diacid)ᵤ copolyamides, in particular the copolyamides corresponding to one of the formulae chosen from 11/10,10/10,36, 11/10,9/10,36, 11/10,18/10,36 and 9,10/10,10/10,36 will be retained.

The molar proportions of (diamine)ₜ and of (diacid)ᵤ are preferably stoichiometric.

The invention also relates to a composition, especially to an adhesive composition, comprising at least one copolyamide according to the first and second aspect of the invention, with the monomer A being chosen from an amino acid and a polyamide corresponding to the (diamine)ₓ·(diacid)_{y} formula.

Such a composition may, in addition, comprise one or more of each of the following compounds:
at least a second polymer preferably obtained from a renewable raw material. This second polymer may, in particular, be chosen from starch, which may be modified and/or formulated, cellulose or its derivatives such as cellulose acetate or cellulose ethers, polylactic acid and polyhydroxyalkanoates; and
at least one additive, preferably of natural and renewable origin, this additive possibly being chosen, in particular, from fillers, fibres, dyes, stabilizers, plasticizers, impact modifiers, pigments, brighteners, antioxidants, UV stabilizers and natural waxes such as those commonly used in the formulations.

Although, with the exception of n-heptyl-11-aminoundecanoic acid, the monomers envisaged in the present description are effectively linear, nothing prevents it from being envisaged that they may be completely or partly branched, cycloaliphatic, partially unsaturated, aromatic or else arylaromatic, on condition that these monomers are definitely obtained from a renewable raw material.

As already indicated previously, the copolyamide according to the invention or else the composition may be used to manufacture adhesives or glues, in particular hot-melt adhesives (HMAs).

Depending on the particular applications envisaged for these hot-melt adhesives, the latter could be conformed so as to be in the form of a film, powder, filaments (monofilament or multifilament), a non-woven cloth, granules, or a thread.

The copolyamides and compositions of the invention may be manufactured according to the usual processes described in the prior art. Reference will be made, in particular, to document DE 4318047 or U.S. Pat. No. 6,143,862.

The present invention will now be described in the examples below, such examples being given purely by way of illustration and obviously non-limitingly.

### EXAMPLE A

### Evaluation of the Properties of Two 11/10,36 and 11/10,10/10,36 Copolyamides According to the Invention Relative to Two 6/6,6/6,12 Copolyamides

| Monomer composition in | 6 | 6, 6 | | Optical Tₘ |
|---|---|---|---|---|
| wt % | (Caprolactam) | (AH salt) | 6, 12 | in ° C. |
| Comparative example 1 | 30 | 20 | 50 | 145-150 |
| Comparative example 2 | 40 | 10 | 50 | 140-144 |

| Monomer composition in | | | | |
|---|---|---|---|---|
| wt % | 11 | 10, 10 | 10, 36 | DSC Tₘ in ° C. |
| Example 1 | 40 | 0 | 60 | 145 |
| Example 2 | 30 | 30 | 40 | 144 |

### EXAMPLE B

### Evaluation of the Properties of 11/10,10/10,36, 11/10,36 and 10,10/10,36 Copolyamides Relative to the 6/6,10/6,12 Copolyamide

| Monomer composition in | 6 | | | Optical |
|---|---|---|---|---|
| wt % | (Caprolactam) | 6, 10 | 6, 12 | Tₘ in ° C. |
| Comparative example 3 | 40 | 30 | 30 | 115-125 |

| Monomer composition in | | | | |
|---|---|---|---|---|
| wt % | 11 | 10, 10 | 10, 36 | DSC Tₘ in ° C. |
| Example 3 | 20 | 15 | 65 | 120 |
| Example 4 | 20 | 0 | 80 | 107 |
| Example 5 | 0 | 20 | 80 | 124 |

Specifically, it is observed that the copolyamides according to the invention melt at a relatively low temperature, especially at melting points between 80 and 150° C. Therefore, the present invention retains all the advantages of HMAs based on oil sources while adding the aspect of 100% organic carbon derived from renewable resources.

1. Copolyamide comprising at least two monomers and corresponding to the following general formula:
A/(diamine)_{z}·(diacid)_{w}
in which:
z represents the carbon number of the diamine and w represents the carbon number of the diacid; and
A is chosen from an amino acid and a polyamide corresponding to the formula (diamine)ₓ·(diacid)_{y}, with x representing the carbon number of the diamine and y representing the carbon number of the diacid,
characterized in that the amino acid, each diamine and each diacid are obtained from a renewable raw material, according to JORA or the ASTM D6866 standard.

2. Copolyamide according to claim 1, wherein z and w are each between 4 and 36.

3. Copolyamide according to claim 2, wherein the diamine is chosen from butanediamine (z=4), nonanediamine (z=9), decanediamine (z=10), undecanediamine (z=11), tridecanediamine (z=13), octadecanediamine (z=18), octadecenediamine (z=18) and diamines obtained from fatty acids.

4. Copolyamide according to claim 2, wherein the diacid is chosen from succinic acid (w=4), azelaic acid (w=9), sebacic acid (w=10), undecanedioic acid (w=11), brassylic acid (w=13), octadecanoic acid (w=18), octadecenoic acid (w=18) and dimers of fatty acids containing 36 carbons.

5. Copolyamide according to claim 1, wherein, A is an amino acid chosen from 11-aminoundecanoic acid and n-heptyl-11-aminoundecanoic acid.

6. Copolyamide according to claim 5, wherein said copolyamide corresponds to one of the formulae chosen from 11/9,18; 11/10,10; 11/10,18; 11/9,36 and 11/10,36.

7. Copolyamide according to claim 1, wherein, A is a polyamide corresponding to the formula (diamine)ₓ·(diacid)_{y}, wherein x and y are each between 4 and 36.

8. Copolyamide according to claim 7, wherein the diamine is chosen from butanediamine (x=4), nonanediamine (x=9), decanediamine (x=10), undecanediamine (x=11), tridecanediamine (x=13), octadecanediamine (x=18), octadecenediamine (x=18) and diamines obtained from fatty acids.

9. Copolyamide according to claim 7, wherein the diacid is chosen from succinic acid (y=4), azelaic acid (y=9), sebacic acid (y=10), undecanedioic acid (y=11), brassylic acid (y=13), octadecanoic acid (y=18), octadecenoic acid (y=18) and dimers of fatty acids containing 36 carbons.

10. Copolyamide according to claim 7, wherein said copolyamide corresponds to one of the formulae chosen from 10,10/9,18; 10,10/10,18; 10,10/9,36 and 10,10/10,36.

11. Copolyamide according to claim 1, wherein said copolyamide comprises, in addition, at least a third monomer, corresponding to the following general formulae:
A/(diamine)_{z}·(diacid)_{w}/(diamine)ₜ·(diacid)ᵤ
in which t represents the carbon number of the diamine and u represents the carbon number of the diacid, each diamine and each diacid being obtained from a renewable raw material.

12. Copolyamide according to claim 11, wherein t and u are each between 4 and 36.

13. Copolyamide according to claim 12, wherein the diamine is chosen from butanediamine (t=4), nonanediamine (t=9), decanediamine (t=10), undecanediamine (t=11), tridecanediamine (t=13), octadecanediamine (t=18), octadecenediamine (t=18) and diamines obtained from fatty acids.

14. Copolyamide according to claim 12, wherein the diacid is chosen from succinic acid (u=4), azelaic acid (u=9), sebacic acid (u=10), undecanedioic acid (u=11), brassylic acid (u=13), octadecanoic acid (u=18), octadecenoic acid (u=18) and dimers of fatty acids containing 36 carbons.

15. Copolyamide according to claim 12, wherein at it corresponds to one of the formulae chosen from 11/10,10/10,36; 11/10,9/10,36; 11/10,18/10,36 and 9,10/10,10/10,36.

16. Composition comprising at least one copolyamide according to claim 1.

17. Composition according to claim 16, wherein said composition further comprises at least a second polymer obtained from a renewable raw material.

18. Composition according to claim 17, wherein the second polymer is chosen from starch, cellulose, cellulose derivatives, polylactic acid and polyhydroxyalkanoates.

19. Composition according to claim 16, wherein said composition further comprises at least one additive chosen from fillers, fibres, dyes, stabilizers, plasticizers, impact modifiers, pigments, brighteners, antioxidants, UV stabilizers and natural waxes.

20. The composition according to claim 16 comprising compositions selected from the group consisting of adhesives, and hot-melt adhesives.

21. The composition according to claim 20, wherein the hot-melt adhesives are in the form of a film, powder, filaments, a non-woven cloth, granules or a thread.
